(19) United States
(12) Patent Application Publication
(10) Pub. No.: US 2008/0235331 A1
(43) Pub. Date: Sep. 25, 2008

(54) SCHEDULING SYNCHRONIZED DEMAND FOR P2P NETWORKS

(76) Inventors: Sharon Melamed, Palo Alto, CA (US); Ori Cohen, Palo Alto, CA (US)

Correspondence Address: SAN FRANCISCO OFFICE OF;NOVAK, DRUCE & QUIGG LLP, 1000 LOUISIANA STREET, FIFTY-THIRD FLOOR, HOUSTON, TX, 77002, US

(21) Appl. No.: 12/021,273

(22) Filed: Jan. 28, 2008

Related U.S. Application Data
(60) Provisional application No. 60/897,525, filed on Jan. 26, 2007.

(51) Int. Cl. G06F 15/16

(52) U.S. Cl. 709/204

(57) ABSTRACT

A method and system are provided to share a file over a P2P network comprising: notifying a plurality of peer devices of a scheduled time during which sharing of a file over the network is to occur; receiving requests from multiple peers from the plurality to participate in sharing of the file during the scheduled time; and distributing different segments of the file to different peers from among the multiple peers.

### CROSS-REFERENCE TO RELATED APPLICATION

This application claims priority to U.S. Provisional Patent Application Ser. No. 60/897,525, filed Jan. 26, 2007, entitled “Scheduled Distribution of Files/Content on Internet Electronic Programming Guide (iEPG) System,” which is expressly incorporated herein by this reference.

### BACKGROUND OF THE INVENTION

1. Field of the Invention

The invention relates in general to peer-to-peer computer networks and more particularly, to efficient delivery of information over such networks.

2. Description of the Related Art

Various protocols and applications exist to deliver files over the Internet. For example, the FTP (file transfer protocol) enables to either upload or download individual files to and from a remote machine that runs an FTP server and/or client. The HTP protocol achieves essentially the same functionality as FTP but using a web interface and HTP protocol. An email attachment allows distribution of a file to multiple users via email. Web sites such as ‘yousendit.com’ offer an application that masks the complexity of FTP using a simple web interface.

Another class of file distribution protocols is based on peer-to-peer networking. Peer-to-peer (P2P) networks are distributed systems that operate at least partially without centralized organization or control. In a typical P2P network, nodes (or “peers”) act as both clients and servers that form an application level network to route messages such as requests to locate a resource. Peers may form a self-organizing overlay network overlayed on a data network. A P2P network ordinarily provides a mechanism to locate resources distributed throughout the network, such as a file stored by one or more peers that are accessible over the network.

The underlying data network may include any network or combination of networks for data communication, including but not limited to the Internet, private networks, local area networks, wide area networks, metropolitan or campus area networks, wireless networks, cellular networks, and so on, as well as any combination of these and any other logical or physical networks that might be used with the same, such as virtual private networks formed over the Internet. More generally, the data network may include any network or combination of networks suitable for forming data connections among devices and establishing a P2P network as described herein. Each peer may be any device connected to the data network and active in the file sharing network described herein, including, for example, any computer, laptop, notebook, personal digital assistant, network-attached storage, cellular phone, media center, set-top box, or other device or combination of devices.

In general, P2P applications perform better (i.e., download files more quickly) when there are more sources available from which to obtain a sought after file. Some P2P applications perform best during periods of peak demand, i.e., when many P2P devices seek to obtain the same file during the same time interval. BitTorrent (BT) is an example of a P2P application that is effective in transferring large files at peak demand (i.e., many users want to obtain the same file at the same time) to a large audience. eDonkey is another example of a P2P application that is effective for transferring files at peak demand. BT uses a central server called a ‘tracker’ to coordinate participating peer devices by managing connections among such peers. eDonkey uses a mechanism called peer exchange to coordinate downloads.

BT is peer-to-peer in nature in that peer devices connect directly to each other to send and receive portions of a file to each other. Large files are broken down into smaller segments. Different segments are distributed among different peers that are simultaneously trying to obtain the file. According to the BT protocol, once an active peer has downloaded a portion of a file, it begins uploading segments that it has received to other downloading peers (“downloaders”) that have not yet downloaded those segments. BT is scalable because throughput increases with the number of peers that simultaneously participating in uploading (transmitting outbound) and downloading (receiving inbound) segments of the file. The greater the number of peers active in sharing file segments, the faster the file downloads will be to individual peers. Since peers upload at the same time they are downloading network bandwidth is used more efficiently and no one peer's bandwidth becomes clogged.

In the BT protocol, a ‘torrent’ file refers to a small metadata file. The metadata file typically can be obtained from a network location such as a web server. The metadata file ordinarily includes information about a file to be obtained using BT such as hashes (typically SHA-1) for its file segments, a mapping of the segments to the file, and a reference (e.g. IP address) to a ‘tracker’. The metadata information is used to manage the replication of a file from multiple peers that cooperate to collectively serve as a source of the file. The hash information facilitates the segmentation of the file for transfer on a segment-by-segment basis and the reassembly of the file from its segments. The tracker information also informs peers simultaneously seeking a file of the location of the tracker server that will coordinate the exchange of segments among sets of cooperating peers.

More particularly, A tracker keeps a list of peers participating in a ‘swarm’. A swarm includes a set of peers participating in distribution of the same file or files. A peer joins a swarm by requesting from a tracker a list of participating peers and by connecting to one or more of those peers. Periodically throughout the transfer of a file, a participating peer will contact the tracker to inform the tracker of the state of the file transfer, how much has been downloaded, uploaded and current state (e.g. starting, finished downloading, stopping).

The BT protocol distinguishes between two kinds of peers depending on their download status. Peers that that have a complete copy of the file and that continue to upload segments to other peers are called seeders. Peers that are still downloading the file are called leechers. The tracker is not involved in the actual distribution of the file. Rather, it keeps meta-information about the peers that are currently active and acts as a rendezvous point for the peers of the swarm.

The tracker maintains a global view of peers participating in a swarm that it coordinates. Participating peers periodically report status of their file transfers and also report when joining or leaving the swarm. Upon joining the torrent, a new peer receives from the tracker a list of active peers to connect to. Typically, the tracker provides a set of the participating peers chosen at random from the total number of active peers. The peers of a set seek to maintain connections to some subset of peers of the set to which they belong. If ever a peer fails to maintain connections with at least some minimum number of participating peers, it contacts the tracker to learn of other participating peers. The subset of peers to which a participating peer is connected is called its peer set.

The peers involved in a swarm cooperate so that each peer can replicate and thereby obtain the file using swarming techniques. The file is broken into equal size segments, and the peers in a peer set exchange segments with one another. The swarming technique allows the implementation of parallel download in which different segments are simultaneously downloaded from and uploaded to different peers. When a peer obtains a new segment, it informs the peers in its peer set of the new segment that it has received. Interactions between peers are primarily guided by two principles. First, a peer preferentially sends data to peers that reciprocally sent data to it. This “tit-for-tat” strategy encourages cooperation and discourages “free-riding”. Second, a peer limits the number of peers that it serves simultaneously to a prescribed number (e.g., ‘N’) of peers and continuously looks for the N best downloaders (in terms of the rate achieved) if it is a seed or the N best uploaders if it is a leecher.

The BT protocol typically implements these policies, using a “choke/unchoke” algorithm. “Choking” involves a temporary refusal to upload to a peer. However, a choking peer's connection to another choked peer to which there is a refusal to upload is not closed, and that other peer might still upload data to the choking peer. A leecher services the N best uploaders among its peer set and chokes the others. The leecher implements a search strategy among its peer set to locate other peers that might offer better service (i.e., a better upload rate) than its current N best uploaders. Seeds essentially apply the same strategy, but based on download rates. Thus, seeds serve the peers to which the download rate is highest.

Active peers ordinarily use a rarest first algorithm to decide which segment to request from peers in a peer set. Participating peers inform each other of the segments they possess. A participating peer seeks to upload the file segment that is least duplicated among the segments it needs in its peer set. The main objective is to maximize the entropy of each segment in the swarm. There exists an exception to the rarest first policy when a peer joins a torrent and has no segments. Since this peer needs to quickly obtain a first segment, it should not ask for the rarest chunk because few peers hold this chunk. Instead, a newcomer uses a random first policy for the first segment and then turns to the rarest first policy for the next ones.

FIG. 1 is an illustrative drawing representing operation of a typical BT protocol in which a ‘torrent’ 100 of peers participate in replication of a file through exchange of file segments. In this example, the file has been broken into five segments A-E. It is assumed that peer 102 has most recently joined the torrent 100 and has not yet received any segments. Peer 102 contacts web server 116 to learn the location of tracker 118. The tracker 118 informs peer 102 of the IP network addresses of a random set of peers 102-114 participating in the torrent 100 and tells the peer 102 which segments each participating peer has. For the sake of simplicity, only a few peers are shown, and the file is broken down into only a few segments. However, it will be appreciated that numerous peers may participate in the torrent 100, and that a file may be broken down into numerous segments. Each peer makes connections with a subset of the participating peers. Different peers posseses different segments. Peers 102-112 are leechers since none of them possess all of the five segments. For example, for example, peer 104 possess segments B and C, and peer 110 possesses only segment D. However, peer 114 is a seeder since it possesses all five segments A-E. As explained above, participating peers seek to download file segments that they lack while simultaneously uploading segments that they already possess to other participating peers that request those segments.

While BT generally has been quite effective, it can be challenging for the average person to use it as it is not typically offered as an integrated solution. For example, a publisher who wishes to distribute a file using BT ordinarily has to go through the stages such as the following:
create a Bittorrent hash value for the file.
create a .torrent file.
register the torrent file with a Bittorrent tracker.
upload the file to a seeding server.
upload the .torrent file to a web server.
publish the file and content information on the web server.

Conversely, users who wish to obtain a file using BT typically must go through steps such as the following:
download and install a Bittorrent client.
find the web server on which the specific torrent is published.
download the torrent file.
open the torrent file in their Bittorrent application.

Recently, some of the BT applications (e.g., Azureues) added RSS capabilities. Such functionality has been referred to as ‘broadcatching’ and is used today by many advanced users. The combination of RSS and Bittorrent provides a method for subscribing to an ongoing series of media files from a website and effectively allows a computer connected to the Internet to behave similar to a digital video recorder (DVR) connected to cable. However, even with the introduction of such capabilities, automatically downloading of specific files based on their RSS notifications remains a technical challenge.

FIG. 2A is an illustrative view of a user device screen display used to subscribe to a BT RSS feed. While the application itself typically does not come with the RSS capabilities, a plugin called RSS feed scanner was installed to demonstrate this capability. In this example, a user has to first sign to a Bittorrent RSS feed from a web site that enables such function. In this illustrative example, the BT application is known as Azureus, and the subscription to a Bittorrent RSS feed is from a web site known as ‘torrentspy.com’ is shown.

FIG. 2B is an illustrative view of a user device screen display that shows the web location of various .torrent files pertaining to a variety of files that are available for downloading using the BT protocol. In this example, each RSS update includes a list of the latest .torrent files available from the example web site. The RSS feed periodically updates the listing.

FIG. 3 is an illustrative view of a user device screen display that shows user selection of a keyword to trigger the automatic downloading of files available through the RSS feed that match the keyword. In this example, the keyword “entourage” was selected as the keyword/filter criteria. Any items (e.g., .torrent file name) that contains this keyword and shows in the RSS feed from selected web site triggers the automatic download of the file.

Many of the most popular BT RSS feeds involve automatic downloads of visual media files such as TV shows and movies, for example. In the age of DVR (digital video recorders) viewers are accustomed to an easy to use Electronic Programming Guide (EPG) that allows them to easily browse a list of channels and show schedules (or search and find their preferred shows) in an intuitive manner. An EPG typically allows users to schedule automatic recordings of future (individual) shows or a complete series. Unfortunately, such a simple integrated user-experience (for both publishers and endusers) does not exist in prior BT RSS implementations.

Thus, there has been a need for an easy to use interface to request the automatic download of files using the BT protocol. Moreover, while prior BT RSS implementations permitted automatic downloading to many user devices, there remains a need for a method of automatic delivery of files using the BT protocol that promotes rapid file transfer. The present invention meets these needs.

### SUMMARY OF THE INVENTION

A method and corresponding system are provided to share a file over a P2P network. A plurality of peer devices are notified of a scheduled time during which a file is to be available for distribution over the network. Requests are received from multiple peers from the plurality to participate in P2P file distribution at the scheduled time. Different segments of the file are distributed to different peers from the multiple peers at about the scheduled time.

The scheduling of a time for participation by a large number of peer devices in a P2P distribution of a file synchronizes demand for the file so that a peak demand occurs at the scheduled time. With peak demand, a larger number of peers participate in the replication of the file. The participation of a larger number of peers ensures rapid distribution of the file to the participating peer devices.

In another aspect, a method and system are provided to share a file over a P2P network. Registrations for the file are received from multiple peers over. When the number of registrations reaches a threshold number, different segments of the file are distributed to different ones of the multiple peers over the P2P.

The threshold can be selected so that the number of peers involved in a P2P exchange of file segments is optimized for rapid download of the file.

These and other features and advantages of the invention will be apparent to persons skilled in the art from the following detailed description of embodiments thereof in conjunction with the appended drawings.

### BRIEF DESCRIPTION OF THE DRAWINGS

The aforementioned features and advantages of the invention, as well as additional features and advantages thereof, will be more clearly understandable after reading the detailed description of embodiments of the invention in conjunction with the following drawings.

FIG. 1 is an illustrative drawing representing operation of a typical BT torrent in which a plurality of peers swarm to participate in replication of a file through exchange of file segments.

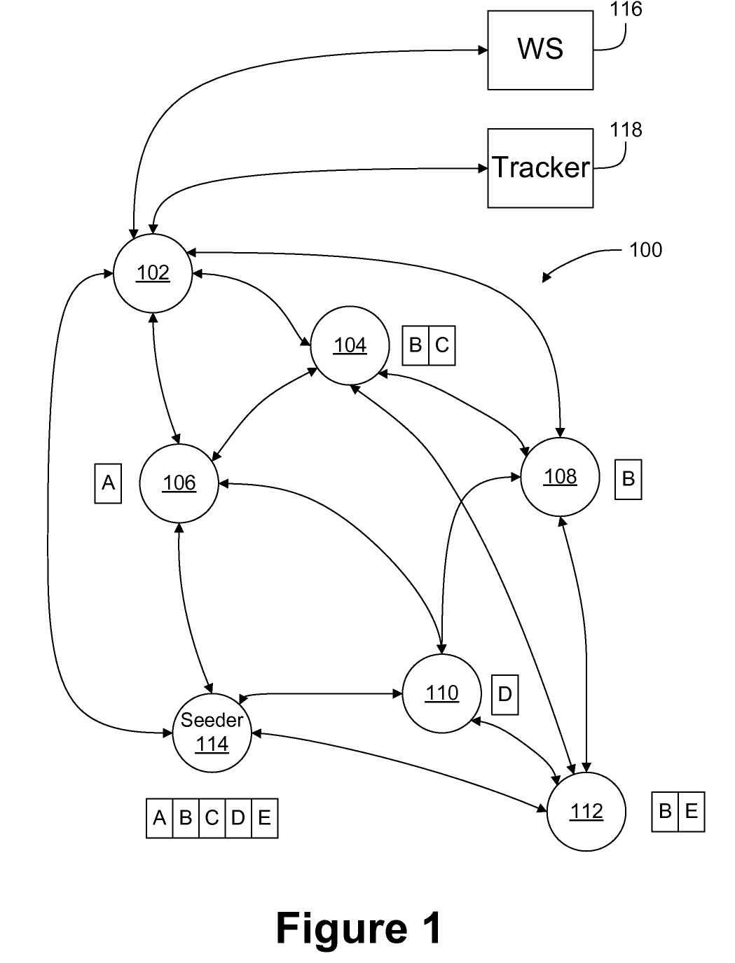

FIG. 2A is an illustrative view of a user device screen display used to subscribe to a BT RSS feed.

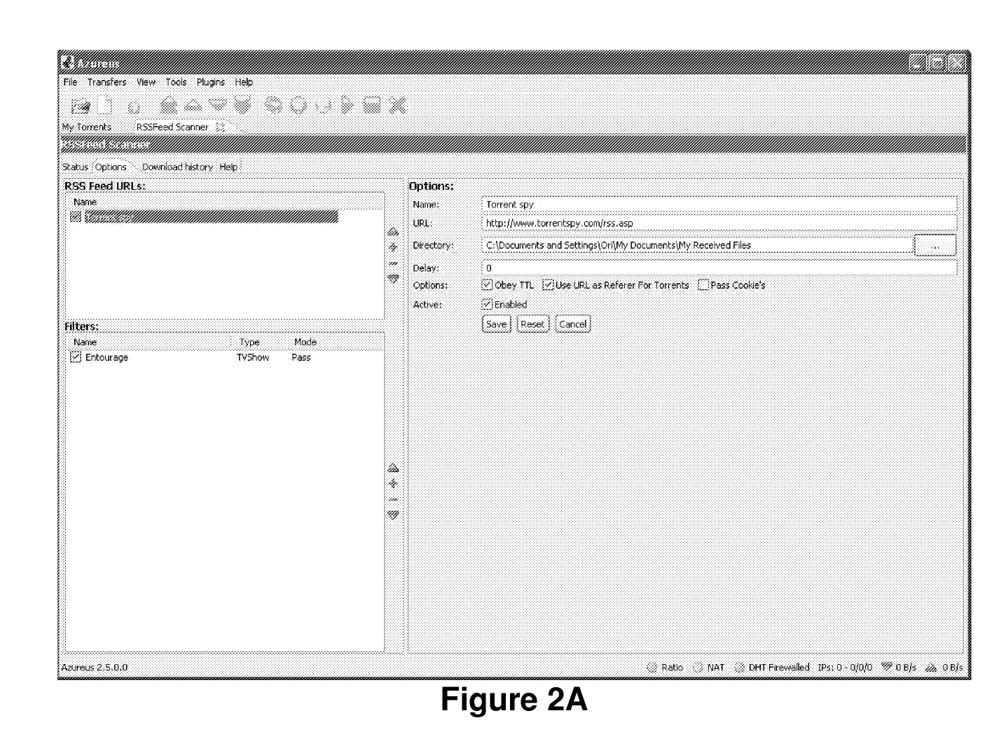

FIG. 2B is an illustrative view of a user device screen display that portrays the web location of various .torrent files pertaining to a variety of files that are available for downloading using the BT protocol.

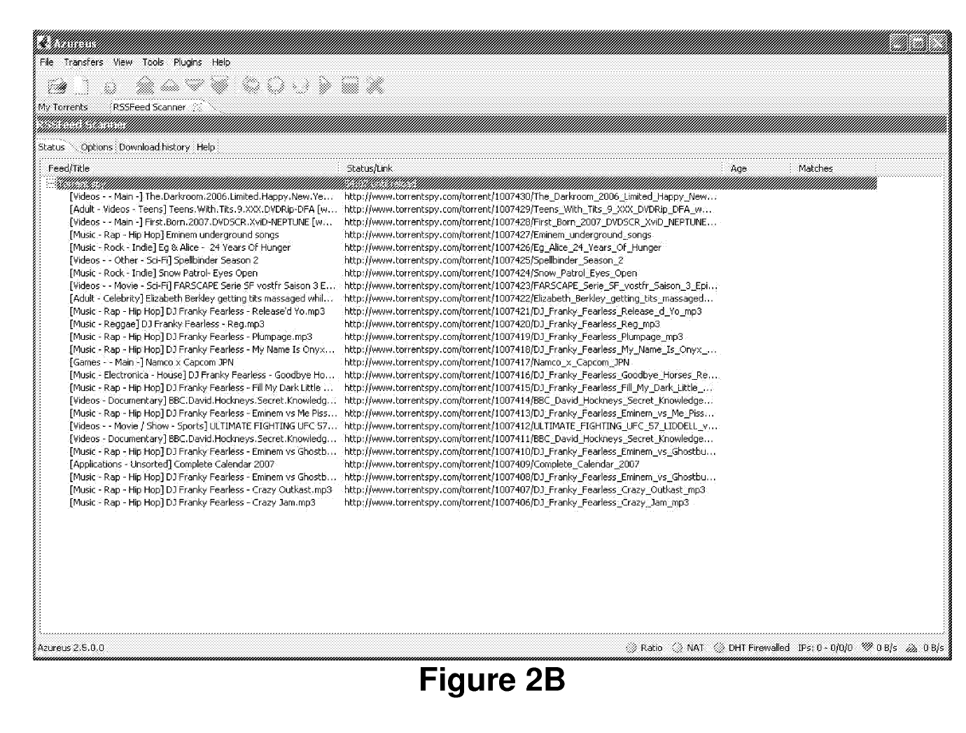

FIG. 3 is an illustrative view of a user device screen display that portrays user selection of a keyword to trigger the automatic downloading of a file if the keyword is matched by one of the items in the RSS feed.

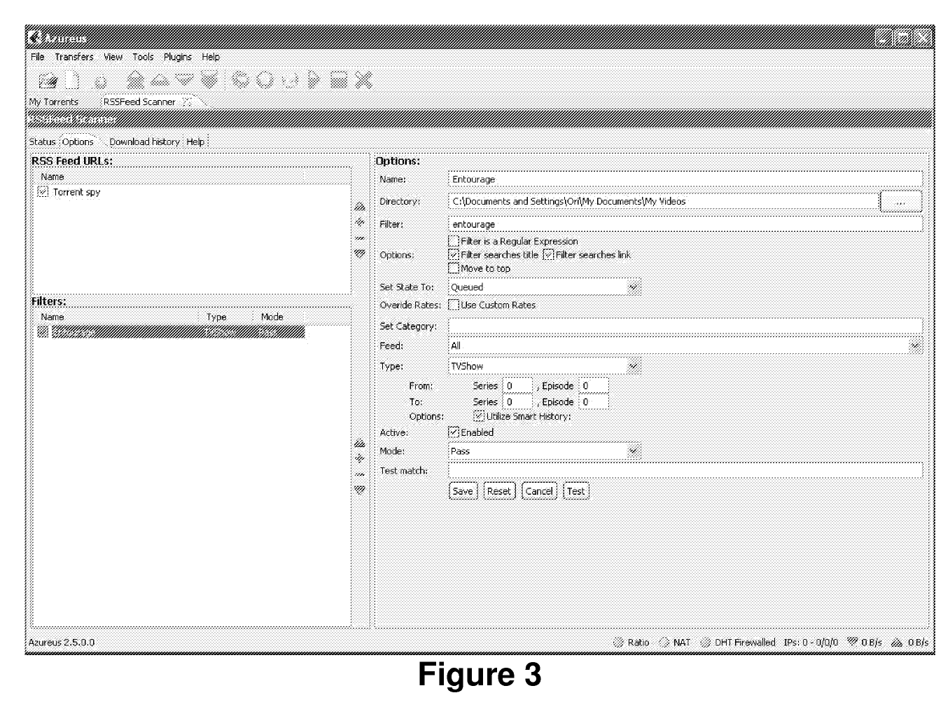

FIG. 4 is an illustrative view of a screen display of an iEPG user interface that portrays a schedule for Shows and Episodes in accordance with some embodiments of the invention.

FIG. 5 is an illustrative view of a screen display of FIG. 4 with several illustrative dialog boxes shown in an open state in accordance with some embodiments of the invention.

FIG. 6 is an illustrative view of a screen display of an iEPG user interface that portrays availability notification fields for a portion of ‘next week’ in accordance with some embodiments of the invention.

FIG. 7 is an illustrative diagram of an architecture of a system to schedule demand for files and to deliver the files using a BT protocol in accordance with some embodiments of the invention.

### DETAILED DESCRIPTION OF THE PREFERRED EMBODIMENTS

The following description is presented to enable any person skilled in the art to make and use a computer implemented system and method and apparatus to use achieve synchronized demand for a file and to achieve cooperative delivery of the file from multiple sources in a peer-to-peer network. Various modifications to the preferred embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and processes are shown in block diagram form in order not to obscure the description of the invention with unnecessary detail. Thus, the present invention is not intended to be limited to the embodiments shown, but is to be accorded the widest scope consistent with the principles and features disclosed herein.

In some embodiments, an Internet electronic program guide (iEPG) provides for simple, user-friendly, scheduling of availability of files over the Internet. While an iEPG is disclosed with reference to the BitTorrent (BT) file distribution protocol, it will be understood that an iEPG can be employed to schedule delivery of files using a client-server model or using other peer-to-peer technologies such as eDonkey, for example.

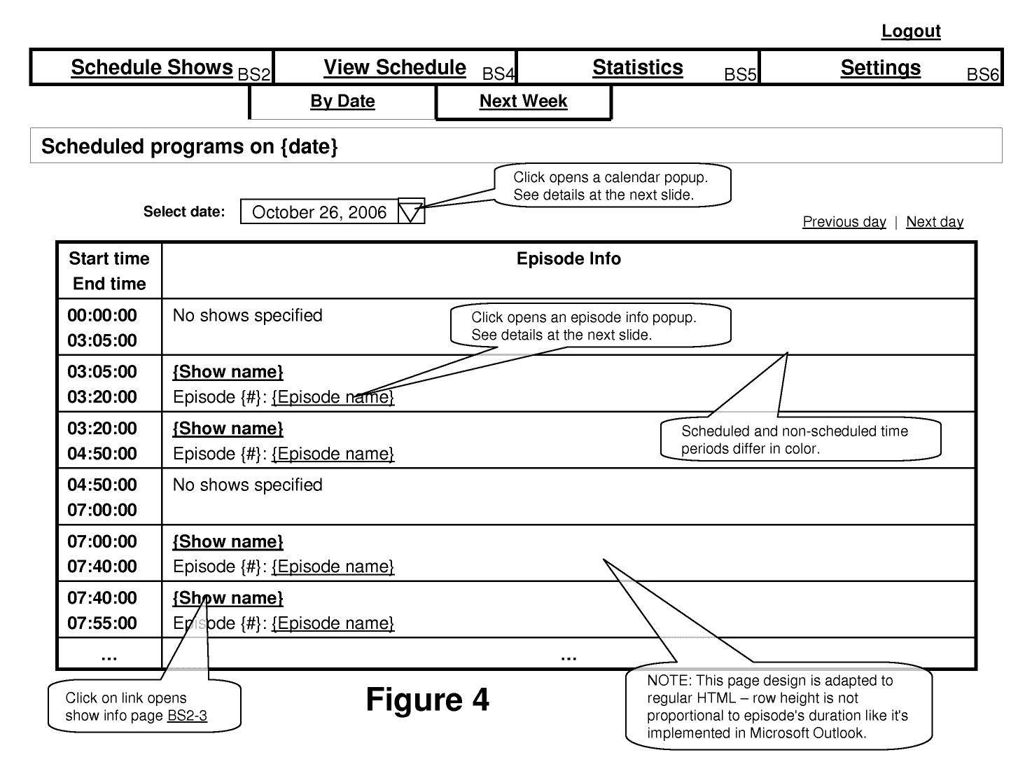

FIG. 4 is an illustrative view of a screen display of an iEPG user interface that portrays an example schedule for Shows and Episodes in accordance with some embodiments of the invention. it will be understood that instances of the iEPG interface may run on a multiplicity of user devices. The iEPG screen display may appear on a network attached computer device user interface screen for example. The illustrative schedule includes notification fields for a portion of a single day in accordance with some embodiments of the invention. The illustrative schedule is for a single ‘channel’. It will be appreciated that there can be numerous overlapping schedules across multiple channels. The times shown in the notification fields can represent a time at which a file (e.g. for a Show or Episode of a Show) is to be released to a torrent or may represent the time when the file will be available for local viewing. In the latter case, a time of release to the torrent (that time not shown on the iEPG in that case) is scheduled sufficiently before the scheduled viewing time such that the device associated with the display screen has enough time to obtain the file, via a torrent replicating the file, prior to the scheduled viewing time.

The illustrative iEPG includes a date selection field through which a user may select a date using a cursor to point and click, for instance. In this example, the date field contains the date Oct. 26, 2006, which signifies that Shows (e.g., television programs) and episodes (e.g., episodes of a television program) for that date are portrayed in the example screen display. The iEPG screen display includes a plurality of notification fields. In the example display, the availability notification fields comprise horizontal rows that are time-ordered according to scheduled distribution time.

The notification fields also include ‘Show name’ information and ‘Episode name’ information. In the illustrated example, the first and fourth availability notification fields do not currently have Show names or Episode names specified, but the second, third, fifth and sixth fields, although the actual names are not set forth in this example. As indicated in the illustrative drawing, a user can obtain additional information about a show by clicking on the Show name in the availability notification field. Similarly, a user can obtain additional information about an episode of a show by clicking on the Episode name in the availability notification field. Scheduled and non-scheduled fields are shown in different colors. In addition, row heights are uniform rather than being proportional to the time period duration.

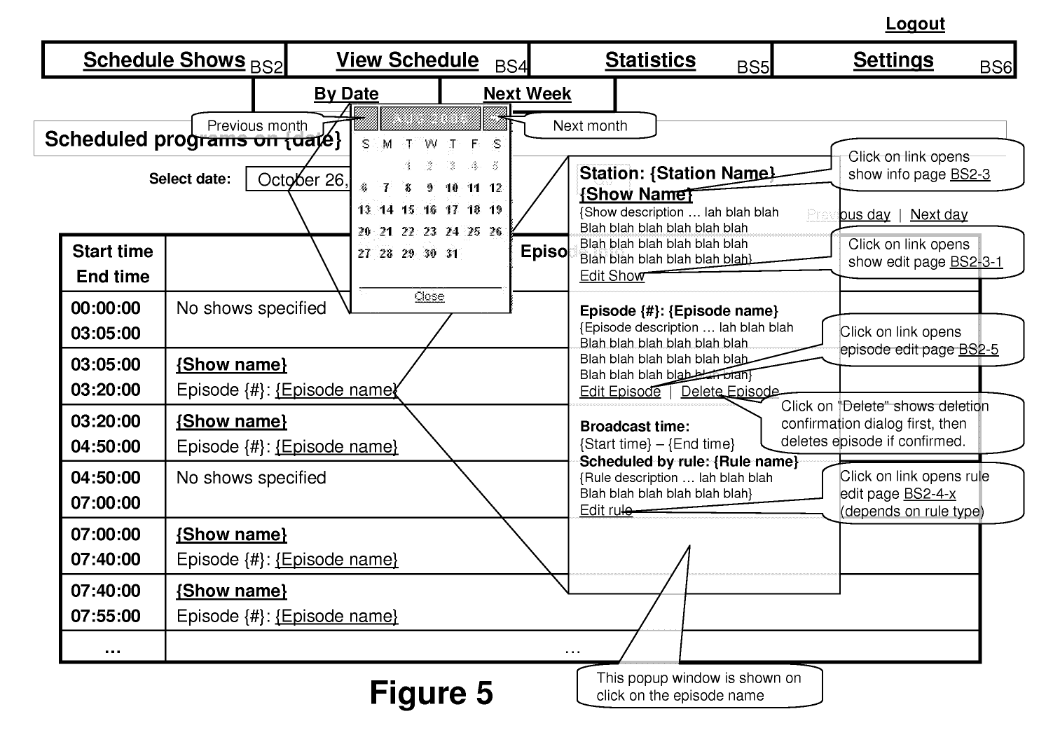

FIG. 5 is an illustrative view of a screen display of FIG. 4 with several illustrative dialog boxes shown in an open state in accordance with some embodiments of the invention. In FIG. 5, a user has actuated the calendar pull-down menu shown in FIG. 4 to open a one month calendar view. A user may select an iEPG screen display for a different date by clicking on the date in the calendar view. A user has actuated one of the Show name links so as to open an information page concerning the named show. A user also has actuated an Episode name link for one of the show names so as to open an information page concerning the named episode.

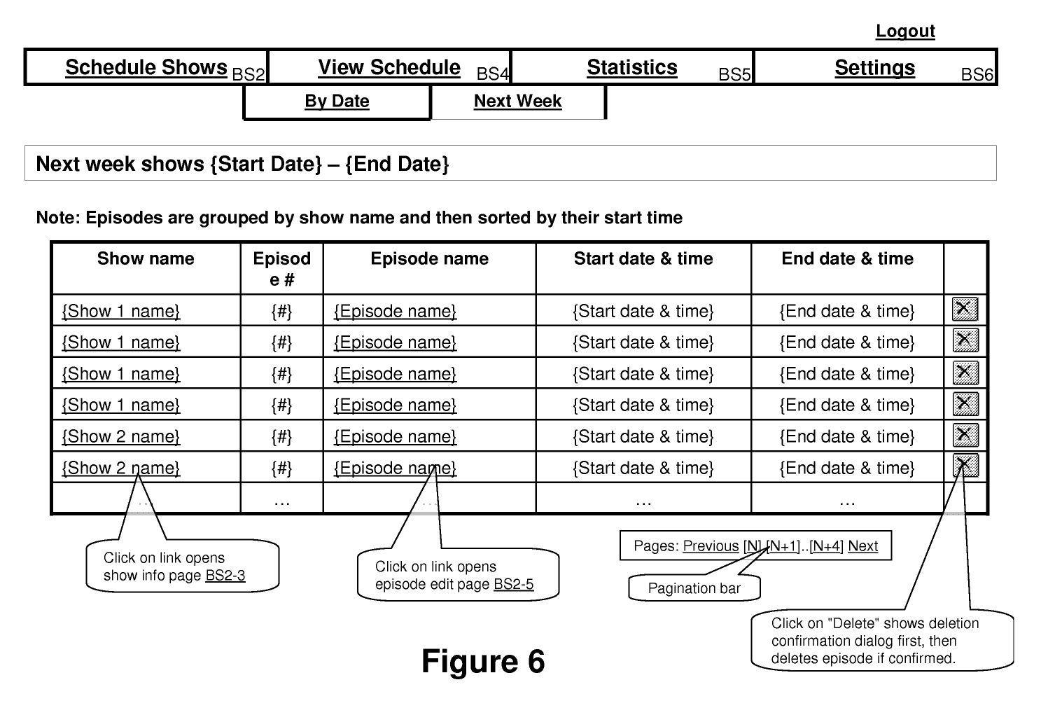

FIG. 6 is an illustrative view of a screen display of an iEPG user interface that portrays availability notification fields for a portion of ‘next week’ in accordance with some embodiments of the invention. In this example screen display, different availability notification fields occupy different rows of the screen display. Each a availability notification field includes a Show name region, Episode number (#) region, Episode name region, a Start date & time region, an End date & time region and a Cancel region as shown. A user may actuate (e.g., click) the respective Show name and Episode name regions to open respective information pages concerning the show and episode. A Delete selection cancels a subscription for a future download.

In some embodiments, a user registers to participate in delivery of files by installing a computer software based agent that runs on the user's device to display and control the iEPG, to automatically request a file at predetermined download time and to control user device participation with other peer devices, in the replication of the file. File content may be delivered for free, with advertisement sponsorship, on a pay-per-view basis or on a subscription basis. A user ‘signs up’ for delivery of a file (e.g., Show or Episode) by clicking on a region of the iEPG portraying the name of the Show or Episode.

The iEPG user interface of FIGS. 4-6 advantageously permits advance scheduling of availability of all file types including audio files, visual media files and files containing TV-like programming, for example. Prior BT RSS delivery did not provide advance information concerning the precise time frame during which a forthcoming file would become optimally available. Rather, with prior BT RSS techniques users learned about file availability once a ‘torrent’ was uploaded and the update information had been published by the RSS feed. Using iEPG, a user knows in advance the time when a file (e.g., TV program or episode) will be distributed.

Moreover, unlike prior BT RSS feed based systems, scheduling is for specific files, not for just any file that matches a keyword search. In particular, prior BT RSS based systems may have achieved synchronized demand for all files that matched a keyword but not for specific files. As a result, it often was the case that a peer device would become choked as it automatically started downloading several files that matched the keyword. In contrast, a system and process in accordance with some embodiments of the present invention creates synchronized demand for specific files. Moreover, a prior RSS feed based system using matching keywords typically polled the RSS feed frequently to locate matching keywords. In contrast, scheduling in accordance with some embodiments of the present invention involves pre-scheduled times when a file will be available for delivery over a P2P network.

In some embodiments, a time interval during which a file is available for sharing is based estimated peer demand. The time interval is selected so that throughout the time interval, a sufficient number of peers are likely to request the file such that download speeds are fast enough for the users to experience rapid downloads throughout the entire time interval. In other words, the time interval is selected so as to optimize the user experience.

For P2P networks that share source information such as BT and eDonkey, download speeds increase with an increasing number of peers requesting a file. In general, it is desirable to have around 20-50 or more peers simultaneously requesting a file in order to ensure that users experience rapid downloads. It will be understood, for example, that the BT protocol operates even if only a very few peers are participating in a swarm. However, with only a few participating peers, download speeds may be painfully slow for large files. Thus, the time interval during which a file is available may be a few hours or even twenty-four hours or more provided that throughout that time interval, peer demand for the file is likely to be high enough to ensure rapid downloads. It will be appreciated that empirical research may be required to decide upon an optimal time interval.

In some embodiments, actual availability of a file to peers during the time interval is managed to ensure rapid download. For instance, during the time interval, a server that receives peer requests for a file during the scheduled time interval actually makes the file available to a torrent only when a sufficient number of peers has requested the file to ensure optimal download speeds for the peers of the torrent. In this manner, multiple torrents may be initiated simultaneously or at staggered times during the time interval. The objective is to ensure that throughout the time interval, there are active torrents of adequate size to ensure an acceptable download rate. It will be understood that empirical research may be required to decide upon an optimal number of peers per torrent.

Moreover, in other embodiments, users may be invited to create synchronized demand. For example, a web page may invite users to register to receive a file download over a P2P network such as BT or eDonkey. The web page may be a part of a social network site, for example. Once a threshold number of users have registered their peer devices to receive the file, the user devices are automatically invited to request a download of the file over the P2P network. The threshold number of is selected to be sufficiently large to ensure that the rate of file download is fast enough for a satisfying user download experience. Thus, in this alternative, synchronized demand is achieved by inviting user participation in a download without specifying a precise time for the download; the download occurs when there is a sufficient expression of interest from the user community.

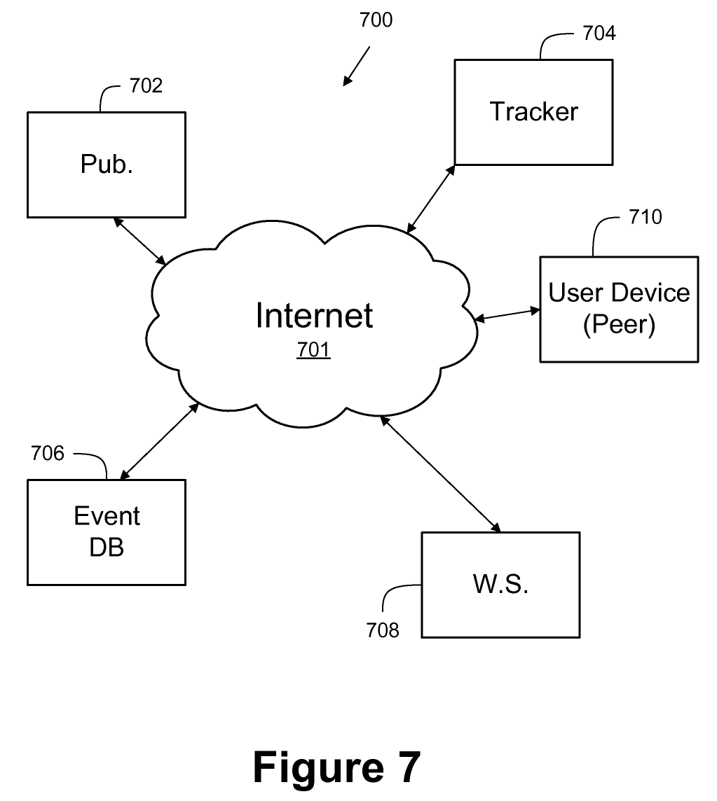

FIG. 7 is an illustrative diagram of an architecture of a system 700 to schedule demand for files and to deliver the files over the Internet 701 using a BT protocol in accordance with some embodiments of the invention. A publisher station 702 comprises a server that stores files such as video files that are to be distributed. The publisher station 702 also can act as an automatic video capture system if it is connected to a video feed through a video capture card, for example (not shown). The publisher 702 can act as a BT seeder that serves the original file until there are more copies available on other peers. Moreover, the publisher station 702 provides access to programmers who populate the iEPG with information about upcoming file availability events. A BT tracker 704 coordinates actions of peer devices that participate in a swarm and that seek to replicate a file previously scheduled for availability. An event database 706 stores information such as, video metadata, syndication rights, advertising restrictions, monetization model (ad, ppv, subscription), about upcoming file availability events. The database 706 also stores file attributes and information (such as file/TV-show name, description, etc). A web server 708 runs an iEPG application that provides web pages such as those of the illustrative display screens of FIGS. 4-6, including pop-up pages for calendar, shows and episodes, for example. The web server 708 manages the users interaction with the schedule/content database through the iEPG and other interfaces. In addition, the web server manges user profiles and community and other user interactins with the registration and delivery process.

A user device 710 includes a computer program application that includes BT client/agent with pre-scheduled notification (such as through an RSS-like feed) of when files are to be available as well as other functionalities. In some embodiments, a local agent program runs on the user device 710 to trigger download as it maintains the user schedule. At the correct time, it will launch a P2P download process for a specific hash. It also interacts with the device's web browser and provides access to local files that the user may play, as well as the P2P stack. The agent also may provide additional services such as sharing user profile and preferences, disk cleanup process, bandwidth throttle and configuration, for example. The agent can be downloaded to the device 710 when the user registers.

Attribute information concerning files to be published in the future is published by the publisher 702. This information may include: file name, file content description, scheduled time of publishing. There may be more than one publisher station 702, and information concerning future file publishing events is stored in the event database 706. The end user device 710 can access this attribute information through an iEPG having user interface screens such as those of FIGS. 4-6. Moreover, users subscribe to future file deliveries through an electronic programming guide.

The publisher station 702 automatically produces a .torrent file, uploads it to the web server 708 and seeds the content, i.e., serves as an initial seeder for a swarm seeking to replicate the file to participating peers The web server 708 publishes notification (such as in RSS format) using an iEPG with the appropriate information concerning scheduled availability of the file. Notably, the time at which a file is to be available is scheduled in advance. The user devices 710 includes an application that listens for notifications of new file-availability. In an RSS implementation, this involves a periodic scan of the RSS feed. A user may subscribe to receive a new file by clicking on an item (e.g., Show or Episode) in the iEPG. As described above, a schedule can be delivered via an RSS feed, and a user device may request a desired file as soon as it becomes available, i.e at the scheduled time. Alternatively, for example a software agent running on the user device can be used to request a .torrent file from the web server 708 at the scheduled time which can be obtained from the iEPG, for example.

Once the scheduled time interval arrives, the user device 710 sends a request to the web server 708 to download the .torrent file. Once the .torrent file has been downloaded, the agent connects to an identified BT tracker and receives a list of available IP addresses of peer devices (not shown) that are available to cooperate with the user device 710 to replication of the desired file, and the download process begins. A torrent may also be available before the file is available on a seeding server; in this case all the above process occurs but the user device 710 will not receive information from the tracker 704 until the file is made available on a seeding server (not shown) that connects to the tracker.

More particularly, the publisher station 702 can be configured (using a web interface) to publish existing files that are placed on specific local directories or to capture video (through a video capture card for example) and to publish these video files based on a programming schedule available to a user device 710 through the iEPG. For example, television programs can be video-captured to files and published one at a time or a complete season can be programmed (for example, it is possible to capture to file and publish the daily news) Specifically, programmers may configure the publisher station 702 to record, save and publish certain files. Once the publisher station 702 defines what episode (or season) is to be recorded, saved to file and published, this information is sent through a secured connection to the event database 706. The publishing station 702 captures the program, for example, and saves it as a file either locally or to a remote machine (not shown). In the case that the file exists (ie there is no need to capture live video and convert to a file), the file will be moved to a seeding server and the publisher system will be responsible for hashing the file, creating the appropriate torrent file and uploading it to the web server.

More particularly, the publishing server 702 hashes the file (e.g., a video file) and creates a .torrent file that contains the hash and the location of the seeding server (not shown). The file is moved manually or by the publishing server 702 to a seeding server (either a bittorent server or a web server). In the case of a BT server, the .torrent file is moved to the seeding server. The publishing server 702 uploads the torrent file web server that makes it available for all subscribers. In the case of a BT seeding server, it connects to the tracker and announces that it has a full copy of the file. The BT seeding server knows to connect to the correct tracker(s) based on the information that is in the torrent file.

The publishing server 702 publishes .torrent file on the web server 708 whereupon (status of file changes from “Scheduled” to “Available”), if the user device 710 was subscribed on a Show or Episodes corresponding to the file—the user device 710 will automatically make a request for the file during the scheduled time interval. The web server 708 communicates with the tracker 704 to authorize tracking. The web server 708 publishes notification to all subscribers, such as user device 710 with the relevant torrent information. This can be done using an RSS feed, for example. The file is seeded by the seed server, which can also be the publishing station 702. That is, a full copy of the file is made available to the swarm through a BT server that connects to the tracker(s) and announces the availability of all pieces. Alternatively, Web seeding may be employed in which the file is put on a standard web server with the URL addresses made part of the torrent file.

The web server 708 communicates with the tracker 704 to authorize tracking. The web server 708 publishes notification to all subscribers, such as user device 710 with the relevant torrent information (this can be done using RSS feed). The file is seeded by a seed server, which can be the publishing station 702. The user device 710 is presented with the iEPG interface of FIGS. 4-6 or with a different interface that shows the schedule (through a search mechanism, a recommendation by another user, popularity charts, for example. Users can use the iEPG to receive .torrent metadata by clicking or hovering-over the relevant show/file. Alternatively, the web server 708 also may include a search function used to register for file downloads. For example, the web server 708 may provide a search request field. A user enters a keyword search request to the field, and in response, matching results are provided that indicate other programs (e.g., shows or programs) to which the user can subscribe directly for downloading. User can sign up to a future file (show) availability by clicking on the appropriate link in the iEPG.

The file is distributed using the BT protocol in some embodiments. The tracker protocol can be enhanced to provide more control on connections between peers participating in a swarm. For example, priority can be given to connections that are on the same ISP. Moreover, connections can be managed so that firewalled peers will not try to connect to each other.

An iEPG concept can be syndicated as follows:

Syndication of iEPG existing data—in this mode, access to iEPG data is provided as a web service; access to the RSS feed is also available through standard means. This mode of operation enables other web sites to display the complete iEPG set (or subset) of the schedule data. Users that use these sites, can subscribe to file availability without going to the central iEPG site. For instance, publisher X may want to encourage users to visit its web site and to stay there rather than visit a central iEPG site. Syndication of data/schedule-updates to the iEPG through other sites.

While embodiments have been disclosed herein with reference to an IEPG, other types of interfaces may be provided to achieve synchronized demand. For example, as explained above, an Internet based search can be employed on a web page search field. For instance, a user may search for “TV Show ABC”; the search result will include a page that contains information about the show as well as schedule of future episodes and reruns with an option to sign up to these with corresponding files to be available at pre-scheduled times. If a user registers on such web page, an agent on the user's device joins the torrent at the scheduled availability time. Alternatively, a device user may click on a “Recommend” field in an iEPG and send a link to a show to another device. A user of the other device then may register to receive a file containing the recommended show. As yet another alternative, A chart may be provided that identifies the most popular shows (ones with the highest number of subscribers). Clicking on any of these links will take the user to the show page where he/she can register for future episodes or reruns. Thus, an iEPG is just one example of a user interface mechanism to stimulate synchronized demand for a file.

The foregoing description and drawings of preferred embodiments in accordance with the present invention are merely illustrative of the principles of the invention. Various modifications can be made to the embodiments by those skilled in the art without departing from the spirit and scope of the invention, which is defined in the appended claims. For example, although the invention has been described with reference to the BT protocol, other protocols such as eDonkey can be used consistent with the invention.

1. A method to share a file over a P2P network comprising:
notifying a plurality of peers over a network of a scheduled time during which a file will be available for sharing over the P2P network;
receiving over the network requests for the file from multiple peers from among the plurality during the scheduled time; and
distributing different segments of the file to different ones of the multiple peers over the P2P network during the scheduled time.

2. The method of claim 1,
wherein notifying includes providing scheduling information over the network to electronic programming guide instances that run on the plurality of peer devices.

3. The method of claim 1,
wherein notifying includes delivering over the network to the plurality of peer devices a web page that includes scheduling information.

4. The method of claim 1,
wherein notifying includes,
delivering over the network to the plurality of peer devices a web page that enables users of the plurality of peer devices to search for the file; and
delivering over the network to the plurality of peer devices scheduling information in response to user search requests for the file.

5. The method of claim 1,
wherein receiving requests includes receiving over the network that user inputs to the plurality of electronic programming guide instances.

6. The method of claim 1,
wherein distributing includes distributing over a BitTorrent P2P network.

7. A method to share a file over a P2P network comprising:
providing notification of a scheduled time during which a file will be available for P2P sharing;
receiving registration information from a plurality of peers prior to the scheduled time to participate in the file sharing; and
receiving from a plurality of registered peers over the network during the scheduled time requests for the file.

8. The method of claim 7 further including:
distributing different segments of the file to different ones of the multiple registered peers over the P2P network.

9. The method of claim 7 further including:
distributing different segments of the file to different ones of the multiple registered peers over a BitTorrent P2P network.

10. A system to share a file over a P2P network comprising:
a web server to provide notification of a scheduled time during which file sharing of a file over the network is to occur;
wherein the web server receives requests from a plurality of peer devices prior to the scheduled time to participate in the file sharing; and
a tracker that receives over the network the requests received from the plurality of peers.

11. The system of claim 10 further including:
a server system that stores availability schedule of specific files;
wherein the availability information is included in the notification provided by the web server.

12. The system of claim 10,
wherein the tracker acts to coordinate participating peers in the sharing of a file.

13. The system of claim 10,
wherein coordinating includes informing participating peers of the network addresses of other participating peers.

14. A method to share a file over a P2P network comprising:
receiving over the network registrations for the file from multiple peers; and
distributing different segments of the file to different ones of the multiple peers over the P2P network when the number of registrations reaches a threshold.

15. The method of claim 14 further including:
inviting the multiple peers to request the file when the threshold number of peers has requested the file.
